(19) United States
(12) Patent Application Publication
(10) Pub. No.: US 2026/0177422 A1
(43) Pub. Date: Jun. 25, 2026

(54) LIGHT DETECTING DEVICE AND LIGHT DETECTING METHOD USING THE SAME

(71) Applicant: Taiwan Semiconductor Manufacturing Company, Ltd., Hsinchu (TW)

(72) Inventors: Chun Lin CHEN, Hsinchu (TW); I-Chung WANG, Hsinchu (TW); De-Fang HUANG, Hsinchu (TW)

(73) Assignee: Taiwan Semiconductor Manufacturing Company, Ltd., Hsinchu (TW)

(21) Appl. No.: 18/999,386

(22) Filed: Dec. 23, 2024

(51) Int. Cl. G01J 1/04; G01J 1/44; G08B 21/18

(52) U.S. Cl. CPC G01J 1/044; G01J 1/44; G08B 21/182

(57) ABSTRACT

A light detecting device includes a light sensor and a controller. The light sensor is configured to generate a first detection value by detecting a region in an optical path of the illumination light at a first time point during a close period of a shutter action timing diagram. The controller is electrically connected with the light sensor and configured to obtain the first detection value; determine whether the first detection value is less than a first preset value; and if the first detection value is less than the first preset value, output an alarm signal.

### BACKGROUND

As the mature process, most of all tools have risk of exposure leakage with illumination shutter, the difficulty detect function will need to be overcome. In the same time, the weakness cause lots of defect occurring, heavy cost, and how to overcome the weakness effectively is one of the most urgent topics.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 illustrates a schematic diagram of an exposure apparatus according to an embodiment of the present disclosure;

FIG. 2 illustrates a schematic diagram of the shutter plate in FIG. 1 covering the entirety of translucent area of the shutter carrier;

FIG. 3 illustrates a schematic diagram of the shutter plate in FIG. 2 exposing a portion of the translucent area of the shutter carrier;

FIG. 4 illustrates a function block diagram of the light detecting device in FIG. 1;

FIG. 5 illustrates a shutter action timing diagram of an exposure program according to an embodiment of the present disclosure;

FIG. 6 illustrates a schematic diagram of a flow chart of the light detecting method of the light detecting device in FIG. 1 according to an embodiment;

FIG. 7 illustrates a schematic diagram of a flow chart of the light detecting method of the light detecting device in FIG. 1 according to another embodiment;

FIG. 8 illustrates a schematic diagram of a flow chart of the light detecting method of the light detecting device in FIG. 1 according to another embodiment;

FIG. 9 illustrates a schematic diagram of a flow chart of the light detecting method of the light detecting device in FIG. 1 according to another embodiment;

FIG. 10 illustrates a schematic diagram of a flow chart of the light detecting method of the light detecting device in FIG. 1 according to another embodiment; and

FIG. 11 illustrates a schematic diagram of a flow chart of the light detecting method of the light detecting device in FIG. 1 according to another embodiment.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

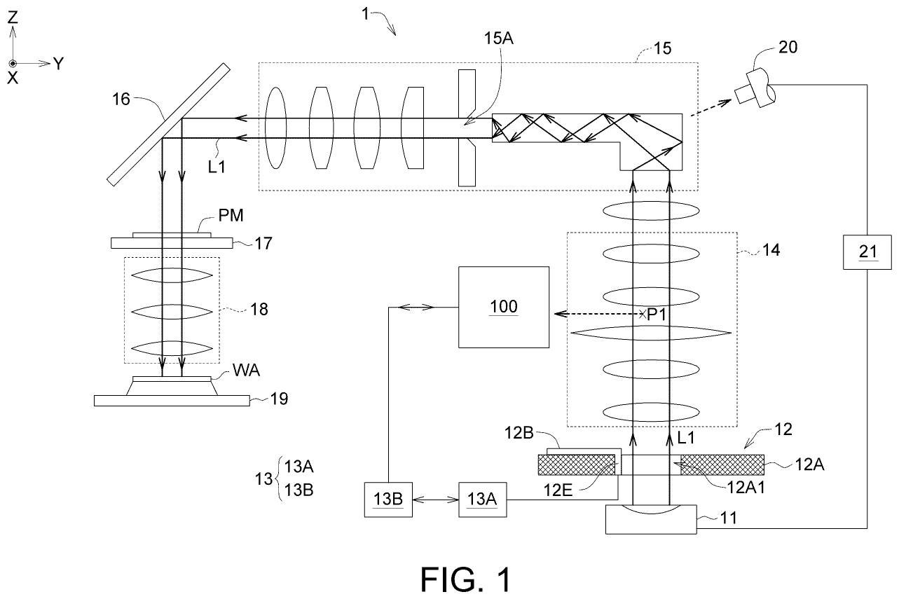

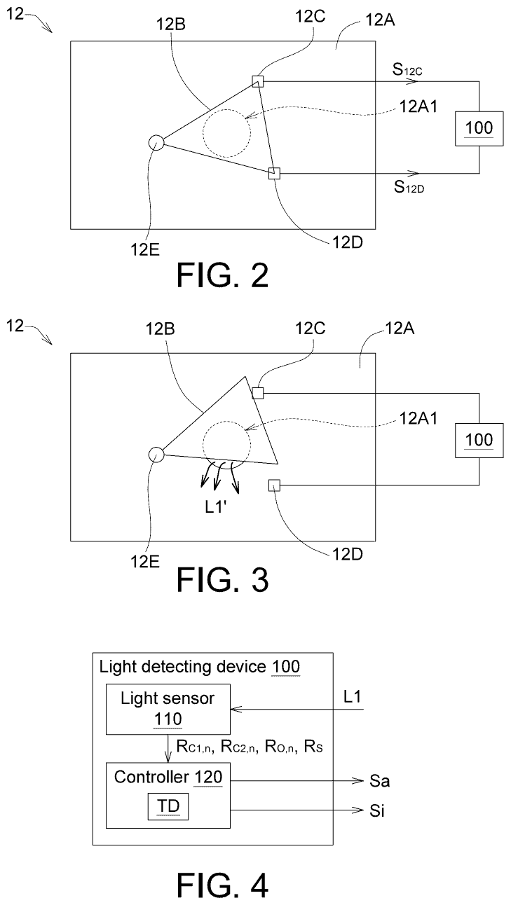

Referring to FIGS. 1 to 3, FIG. 1 illustrates a schematic diagram of an exposure apparatus 1 according to an embodiment of the present disclosure, FIG. 2 illustrates a schematic diagram of the shutter plate 12B in FIG. 1 covering the entirety of translucent area 12A1 of the shutter carrier 12A, and FIG. 3 illustrates a schematic diagram of the shutter plate 12B in FIG. 2 exposing a portion of the translucent area 12A1 of the shutter carrier 12A.

As illustrated in FIG. 1, the exposure apparatus 1 includes a light source 11, a shutter module 12, a driving module 13, an illumination module 14, a collimating module 15, a reflecting element 16, a photo-mask stage 17, a projection module 18, a wafer stage 19, a photodetector 20, a controller 21 and a light detecting device 100.

As illustrated in FIG. 1, the exposure apparatus 1 is, for example, an optical scanner for wafer exposure. The light source 1 may emit an illumination light (or exposure light) to a wafer WA through the shutter module 12, the illumination module 14, the collimating module 15, the reflecting element 16, the photo-mask (or reticle) PM and the projection module 18 in order. The photo-mask PM is disposed on the photo-mask stage 17, and the wafer WA is disposed on the wafer stage 19.

As illustrated in FIG. 1, a slit-shaped illumination area in the collimating module 15 which is set over the photo-mask PM with a reticle blind is illuminated by the illumination light L1 (or exposure light) emitted from the light source 11. The photo-mask PM, on which a circuit pattern is formed as transparent or opaque patterns, is held on the photo-mask stage 17. The photo-mask stage 17 may be precisely driven within the XY plane, and may also be moved in the predetermined scanning direction (Y direction), by a photo-mask stage driving mechanism. The projection module 18 projects the illumination light L1 passing through the photo-mask M1 on to the wafer WA placed on the wafer stage 19. By synchronous driving of the photo-mask stage 17 and the wafer stage 19, which relatively moves the photo-mask stage 17 in a scanning direction (for example, +Y direction) and moves the wafer stage 19 on which the wafer WA to be exposed is placed, in opposing the scanning direction (for example, −Y direction). By this scanning movement, a band of illumination light is scanned in an exposure area on the wafer WA to form a mask pattern image on/in a photo resist layer coated on the wafer WA. In addition, the driving module 13 includes a motor 13A and a driver 13B, wherein the driver 13B is connected with the motor 13A for driving the motor 13A to rotate. The illumination module 14 includes at least one optical lens for guiding the illumination light L1 to the collimating module 15. The collimating module 15 includes the slit-shaped illumination area 15A for collimate the illumination light L1. The reflecting element 16 may reflect the illumination light L1 to the photo-mask PM. The projection module 18 includes at least one optical lens for guiding the illumination light L1 to the wafer WA. The photodetector 20 may detect the illumination light L1 at any point of the optical path of the illumination light L1. The controller 21 is electrically connected with the light source 11 and the photodetector 20.

As illustrated in FIGS. 1 to 3, the shutter module 12 includes a shutter carrier 12A, a shutter plate 12B, a first position sensor 12C, a second position sensor 12D and a pivot shaft 12E. The shutter plate 12B is pivotally connected with the shutter carrier 12A by the pivot shaft 12E. The pivot shaft 12E is connected the motor 13A and drives the shutter carrier 12A to rotate. The shutter carrier 12A has a translucent area 12A1. The translucent area 12A1 is, for example, a through hole. The shutter plate 12B may rotate by 360 degrees to cover the translucent area 12A1 (as illustrated in FIG. 2) or expose the translucent area 12A1 (as illustrated in FIG. 3). When the shutter plate 12B exposes the translucent area 12A1, the light leakage L1′ of the illumination light L1 leaks from the translucent area 12A1. When the shutter plate 12B covers the entirety of the translucent area 12A1, the illumination light L1 may be occluded by the shutter plate 12B.

As illustrated in FIGS. 1 to 3, the first position sensor 12C and the second position sensor 12D may be electrically connected with the light detecting device 100. When the shutter plate 12B covers the first position sensor 12C, the first position sensor 12C generates a first position signal S_{12C} and transmitted to the light detecting device 100. When the shutter plate 12B covers the second position sensor 12D, the second position sensor 12D generates a second position signal S_{12D} and transmitted to the light detecting device 100. In addition, the first position sensor 12C and the second position sensor 12D are, for example, proximity sensors.

As illustrated in FIGS. 1 to 3, when the shutter plate 12B covers both of the first position sensor 12C and the second position sensor 12D, the translucent area 12A1 may be entirely covered by the shutter plate 12B. The first position sensor 12C, the second position sensor 12D and the pivot shaft 12E may construct three vertices of a first shape, and the shutter plate 12B has a second shape the same as or similar to the first shape. In an embodiment, each of the first shape and the second shape is, for example, a triangular shape. The first shape and the second shape may cover the entirety of the translucent area 12A1.

As illustrated in FIGS. 1 and 3, the light detecting device 100 may detect the whether the illumination light L1 leaks from the shutter module 12. When the light detecting device 100 detects the light leakage L1′, the light detecting device 100 may output an alarm signal Sa. The controller 21 may control an indicator (not illustrated) to display an alarm feature, for example, text, sound, light, vibration or a combination thereof. The indicator is, for example, a monitor, a speaker, a vibrator or a combination thereof. In another embodiment, the controller 21 may suspend (or stop) the exposure operation according to the alarm signal Sa.

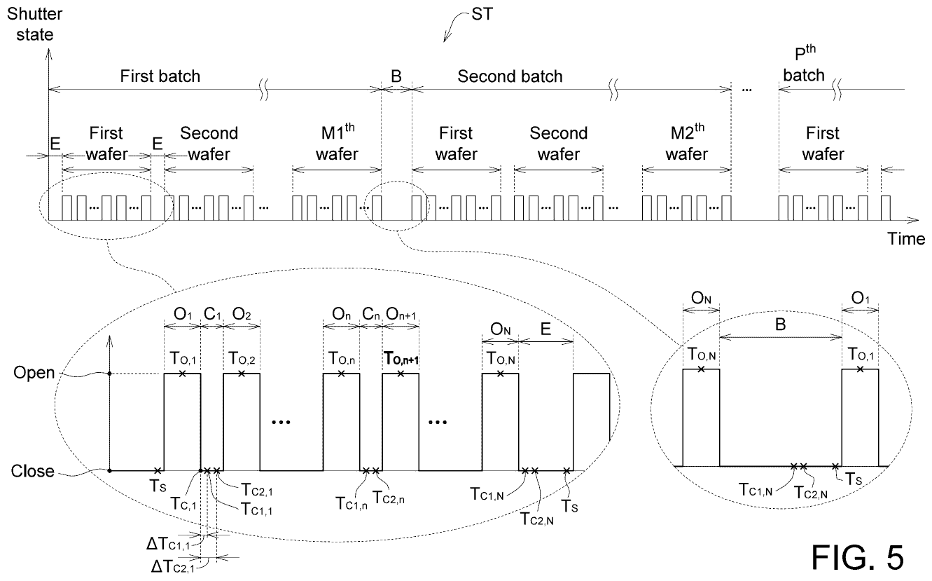

Referring to FIGS. 4 and 5, FIG. 4 illustrates a function block diagram of the light detecting device 100 in FIG. 1, and FIG. 5 illustrates a shutter action timing diagram ST of an exposure program according to an embodiment of the present disclosure.

As illustrated in FIG. 4, the light detecting device 100 includes a light sensor 110 and a controller 120. The light sensor 110 may detect the illumination light L1 at any point of the optical path of the illumination light L1. The controller 120 is electrically connected with the light sensor 110, the first position sensor 12C, the second position sensor 12D and the driving module 13.

As illustrated in FIG. 5, the shutter action timing diagram ST presents a relationship between shutter states vs. time. The shutter action timing diagram ST may be obtained in advance and be stored in a memory which is disposed in the controller 120 or is disposed outside the controller 120 and accessible by the controller 120. In shutter action timing diagram ST, a plurality of wafer batch procedures (for example, the number of the wafer batch procedures is P which is a positive integer greater than 1) may be performed in order. Each wafer batch includes at least one wafer to be exposed. For example, in first wafer batch procedure, a plurality of wafer (for example, the number of the wafer is M1 which is a positive integer greater than 1) may be exposed in order. In second wafer batch procedure, a plurality of wafers (for example, the number of the wafer is M2 which is a positive integer greater than 1) may be performed in order. The “close” is the state that the shutter plate 12B covers the translucent area 12A1 as illustrated in FIG. 2 while “open” is the state that the shutter plate 12B exposes at least one portion of the translucent area 12A1. In an embodiment, the number of the open periods O₁ to O_{N} may be, for example, N, wherein N may be a positive integer greater than 1. The value of N depends on the number of the exposure regions in the wafer. The symbol O_{N} represents the nth open period of the shutter plate 12B for the same wafer, wherein the subscript “n” may a positive integer ranging between 1 to N.

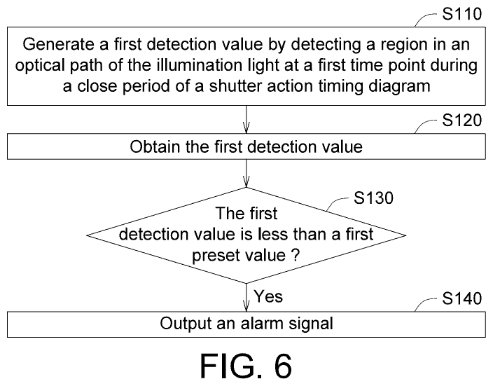

Referring to FIG. 6, FIG. 6 illustrates a schematic diagram of a flow chart of the light detecting method of the light detecting device 100 in FIG. 1 according to an embodiment.

In step S110, as illustrated in FIGS. 4 and 5, the light sensor 110 generates a first detection value R_{C1,n} by detecting a region P1 in an optical path of the illumination light L1 at a first time point T_{C1,n} during the close period Cₙ of the shutter action timing diagram ST, wherein “n” may range between 1 and N. The symbol T_{C1,n} represents a time point T_{C1} in the nth close period Cₙ of the shutter plate 12B for the same wafer. In an embodiment, the light sensor 110 may continuously generate the detection value by continuously detecting the region P1 in the optical path of the illumination light L1 over a continuous period of time, and the controller 120 may obtain (or read) the detection value at any time.

In step S120, the controller 120 obtains (or reads) the first detection value R_{C1,n}.

In step S130, the controller 120 determines whether the first detection value R_{C1,n} is less than the first preset value. If the first detection value R_{C1,n} is less than the first preset value, the process proceeds to step S140. If the first detection value R_{C1,n} is not less than (for example, equal to or greater than) the first preset value, the controller 120 may neglect the first detection value R_{C1,n}.

In step S140, as illustrate in FIG. 4, the controller 120 outputs the alarm signal Sa.

Furthermore, as illustrated in FIG. 5, in the close period Cₙ of the shutter action timing diagram ST, if the first detection value R_{C1,n} at the first time point T_{C1,n} is less than the first preset value, it means the illumination light L1 leaks from the translucent area 12A1, as illustrated in FIG. 3. The less the detection value is, the brighter the detected region is, and the greater the detection value is, the darker the detected region is. In an embodiment, the first detection value R_{C1,n} is, for example, the value displaying on a monitor (or display). The first preset value is, for example, 1500, or even less or greater. In addition, the first detection value R_{C1,n} is related to a detected voltage of the light sensor 110. The greater the light leakage is, the greater the detected voltage is. The light sensor 110 may convert the detected voltage into the detection value.

In addition, as illustrated in FIG. 5, in the close period C1, a first time interval T_{C1,1} between a close time point T_{C,1} and the first time point T_{C1,1} may depend on a rotation speed (for example, rpm (revolution per minute)) of the shutter plate 12B. During the shutter plate 12B rotates by 360 degrees, the translucent area 12A1 is covered once (corresponding to the close period in a cycle) and exposed once (corresponding to the open period in the same cycle). The fast the rotation speed of the shutter plate 12B is, the less the time interval (for example, the first time interval ΔT_{C1,1}) is. In an embodiment, the first time interval ΔT_{C1,1} is, for example, 0.03 second; however, the disclosed embodiments are not limited to this.

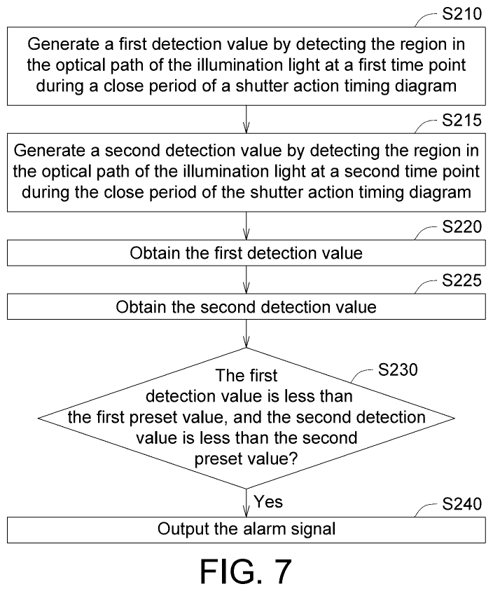

Referring to FIG. 7, FIG. 7 illustrates a schematic diagram of a flow chart of the light detecting method of the light detecting device 100 in FIG. 1 according to another embodiment.

In step S210, as illustrated in FIGS. 4 and 5, the light sensor 110 generates the first detection value R_{C1,n} by detecting the region P1 in the optical path of the illumination light L1 at the first time point T_{C1,n} during the close period Cₙ of the shutter action timing diagram ST, wherein n may range between 1 and N.

In step S215, as illustrated in FIGS. 4 and 5, the light sensor 110 generates a second detection value R_{C2,n} by detecting the region P1 in the optical path of the illumination light L1 at a second time point T_{C2,n} during the close period Cₙ of the shutter action timing diagram ST. The symbol T_{C2,n} represents a time point T_{C2} in the n^{th} close period Cₙ of the shutter plate 12B for the same wafer.

In step S220, the controller 120 obtains (or reads) the first detection value R_{C1,n}.

In step S225, the controller 120 obtains (or reads) the second detection value R_{C2,n}.

In step S230, the controller 120 determines whether the first detection value R_{C1,n} is less than the first preset value, and the second detection value R_{C2,n} is less than the second preset value. If the first detection value R_{C1,n} is less than the first preset value, and the second detection value R_{C2,n} is less than the second preset value, the process proceeds to step S240. If the first detection value R_{C1,n} is not less than the first preset value, and the second detection value R_{C2,n} is not less than the second preset value, the controller 120 may neglect the first detection value R_{C1,n} and the second detection value R_{C2,n}.

Furthermore, in the close period Cₙ of the shutter action timing diagram ST, if the second detection value R_{C2,n} at the second time point T_{C2,n} is less than the second preset value, it means the illumination light L1 leaks from the translucent area 12A1, as illustrated in FIG. 3. The less the detection value is, the brighter the detected region is, and the greater the detection value is, the darker the detected region is. In an embodiment, the second detection value R_{C2,n} may be greater than the first detection value R_{C1,n}. In an embodiment, the second detection value R_{C2,n} is, for example, the value displaying on the monitor (or display). The second preset value is, for example, greater than the first preset value. For example, the first preset value is, for example, 1500, or even less or greater, while the second preset value is, for example, 1550, or even less or greater. In addition, the second detection value R_{C2,n} is related to the detected voltage of the light sensor 110. The greater the light leakage is, the greater the detected voltage is. As illustrated in FIG. 5, a second time interval ΔT_{C2,1} between the close time point T_{C1} and the second time point T_{C2,1} may depend on the rotation speed of the shutter plate 12B. The fast the rotation speed of the shutter plate 12B is, the less the time interval (for example, the second time interval ΔT_{C2,1}) is. The second time interval ΔT_{C2,1} is, for example, 0.06 second; however, the disclosed embodiments are not limited to this. In an embodiment, in each of at least one of the close periods C1 to Cn, if the first detection value RC1 is less than the first preset value, and the second detection value RC2 is less than the second preset value, then the controller 120 may output the alarm signal Sa. In another embodiment, in each of at least one of the close periods C1 to Cn, if the first detection value RC1 is less than the first preset value, or the second detection value RC2 is less than the second preset value, then the controller 120 may output the alarm signal Sa. In step S240, as illustrate in FIG. 4, the controller 120 outputs the alarm

signal Sa.

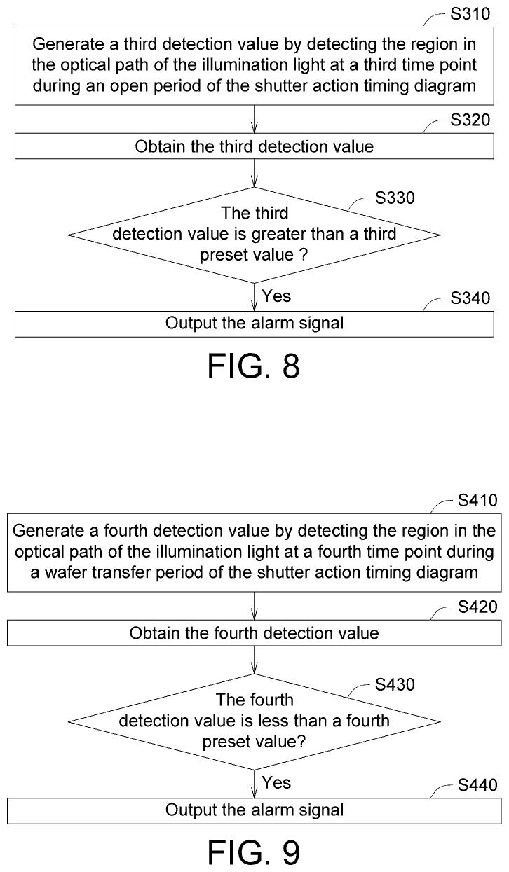

Referring to FIG. 8, FIG. 8 illustrates a schematic diagram of a flow chart of the light detecting method of the light detecting device 100 in FIG. 1 according to another embodiment.

In step S310, as illustrated in FIGS. 4 and 5, the light sensor 110 generates a third detection value R_{O,n} by detecting the region P1 in the optical path of the illumination light L1 at a third time point T_{O,n} during the open period Oₙ of the shutter action timing diagram ST.

In step S320, the controller 120 obtains (or reads) the third detection value R_{O,n}.

In step S330, the controller 120 determines whether the third detection value R_{O,n} is greater than a third preset value. If the third detection value R_{O,n} is greater than the third preset value, the process proceeds to step S240. If the third detection value R_{O,n} is not greater than the third preset value, the controller 120 may neglect the third detection value R_{O,n}.

Furthermore, in the open period Oₙ of the shutter plate 12B, the third detection value R_{O,n} should be equal to or less than the third preset value if the light sensor 110 is normal. Thus, if the third detection value R_{O,n} is greater than the third preset value, it means that the light sensor 110 fails, and accordingly the controller 120 outputs the alarm signal Sa. In an embodiment, the third preset value is, for example, 200, or even greater or even less.

In step S340, as illustrate in FIG. 4, the controller 120 outputs the alarm signal Sa.

Referring to FIG. 9, FIG. 9 illustrates a schematic diagram of a flow chart of the light detecting method of the light detecting device 100 in FIG. 1 according to another embodiment. The procedures of FIG. 9 may be performed on each of at least one of the wafer transfer periods E of the shutter action timing diagram ST in FIG. 5.

In step S410, as illustrated in FIGS. 4 and 5, the light sensor 110 generate a fourth detection value R_{S} by detecting the region P1 in the optical path of the illumination light L1 at a fourth time point T_{S} during a wafer transfer period E of the shutter action timing diagram ST. The wafer transfer period E is located, for example, between two wafer exposure procedures and/or located before the first wafer exposure procedure. In the wafer transfer period E, the shutter plate 12B covers the translucent area 12A1.

In step S420, the controller 120 obtains (reads) the fourth detection value R_{S}.

In step S430, the controller 120 determines whether the fourth detection value R_{S} is less than a fourth preset value. If the fourth detection value R_{S} is less than the fourth preset value, the process proceeds to step S440. If the fourth detection value R_{S} is not less than the fourth preset value, the process proceeds to step S440, the controller 120 may neglect the fourth detection value R_{S}.

Furthermore, in the wafer transfer period E, the wafer is unloaded from wafer stage, and the next wafer is transferred to the wafer stage and an exposure preparatory work (for example, a positioning between the photo-mask PM and the wafer WA) is performed. In the wafer transfer period E of the shutter action timing diagram ST, if the fourth detection value R_{S} at the fourth time point T_{S} is less than the first preset value, it means the illumination light L1 leaks from the translucent area 12A1, as illustrated in FIG. 3. The less the detection value is, the brighter the detected region is, and the greater the detection value is, the darker the detected region is. In an embodiment, the fourth detection value R_{S} is, for example, the value displaying on a monitor (or display). In an embodiment, the fourth preset value is greater than the first preset value and the second preset value. For example, the fourth preset value is, for example, 1650, or even less or greater. In addition, the fourth detection value R_{S} is related to the detected voltage of the light sensor 110. The greater the light leakage is, the greater the detected voltage is. In another embodiment, the procedures of FIG. 9 may be performed on each of at least one of the batch conversion periods B of the shutter action timing diagram ST in FIG. 5, wherein in the batch conversion period B, the last wafer of a batch is unloaded from wafer stage, and the first wafer of the next batch is transferred to the wafer stage and an exposure preparatory work (for example, a positioning between the photo-mask PM and the wafer WA) is performed.

In step S440, as illustrate in FIG. 4, the controller 120 outputs the alarm signal Sa.

As described above, the controller 120 may determine whether the light leakage occurs in the close period Cn of the shutter action timing diagram ST and/or determine whether the light sensor 110 fails according to the detection value of the light sensor 110. If the light leakage occurs in the close period Cn of the shutter action timing diagram ST, and/or the light sensor 110 fails, the alarm signal Sa may be generated or outputted.

In addition, the controller 120 is further configured to adjust the luminous intensity of the illumination light L1 emitted by the light source 11 according to an illumination ratio (IL ratio) Ir.

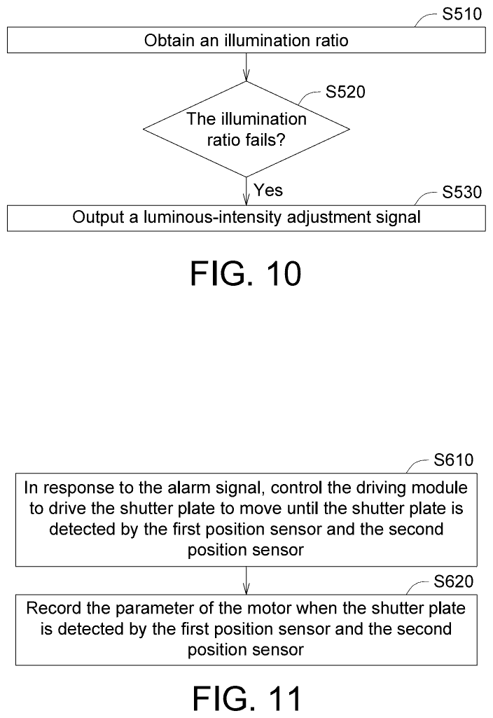

Referring to FIG. 10, FIG. 10 illustrates a schematic diagram of a flow chart of the light detecting method of the light detecting device 100 in FIG. 1 according to another embodiment. The procedures of FIG. 10 may be performed on each of at least one of the wafer transfer periods E of the shutter action timing diagram ST in FIG. 5, and/or on each of at least one of the batch conversion periods B of the shutter action timing diagram ST in FIG. 5.

In step S510, the controller 120 may obtain the illumination ratio Ir.

In step S520, in response to the alarm signal Sa, the controller 120 determines whether the illumination ratio Ir fails. If the illumination ratio Ir fails, the process proceeds to step S530. If the illumination ratio Ir does not fail, the controller 120 may neglect the alarm signal Sa.

In step S530, as illustrated in FIG. 4, the controller 120 outputs a luminous-intensity adjustment signal Si.

Furthermore, the photodetector 20 may sense the luminous intensity of the illumination light L1, and the controller 21 may issue the illumination ratio Ir according to the detected signal of the photodetector 20. When the illumination ratio Ir is not issued (the illumination ratio Ir fails), it means that the photodetector 20 does not sense the luminous intensity of the illumination light L1 (for example, the translucent area 12A1 is covered by the shutter plate 12B, or the luminous intensity of the illumination light L1 is too weak). In an embodiment, when the light leakage L1′ (the light leakage L1′ is illustrated in FIG. 3) is detected, but the illumination ratio Ir is not issued, it means the luminous intensity of the illumination light L1 is too weak and insufficient to be detected by the photodetector 20, and accordingly the controller 120 outputs the luminous-intensity adjustment signal Si to the controller 21. The controller 21 may adjust (for example, increases) the luminous intensity of the illumination light L1 according to the luminous-intensity adjustment signal Si to make the photodetector 20 be capable of sensing the light leakage in the close period Cn of the shutter action timing diagram ST.

Referring to FIG. 11, FIG. 11 illustrates a schematic diagram of a flow chart of the light detecting method of the light detecting device 100 in FIG. 1 according to another embodiment. The procedures of FIG. 11 may be performed on each of at least one of the wafer transfer periods E of the shutter action timing diagram ST in FIG. 5, and/or on each of at least one of the batch conversion periods B of the shutter action timing diagram ST in FIG. 5.

In step S610, as illustrated in FIG. 1. in response to the alarm signal Sa (for example, as illustrated in FIG. 3, the shutter plate 12B exposes the translucent area 12A1 during the close period of the of the shutter action timing diagram ST in FIG. 5), the controller 120 controls the driving module 13 to drive the shutter plate 12B to rotate until the shutter plate 12B is detected by the first position sensor 12C and the second position sensor 12D, as illustrated in FIG. 2.

In step S620, the controller 120 may record the parameter of the motor 13A when the shutter plate 12B is detected by the first position sensor 12C and the second position sensor 12D.

Furthermore, as illustrated in FIG. 3, the driver 13B may control the motor 13A to drive the shutter plate 12B to rotate until the shutter plate 12B is detected by the first position sensor 12C and the second position sensor 12D, as illustrated in FIG. 2. The controller 120 may record the parameter of the motor 13A when the shutter plate 12B is detected by the first position sensor 12C and the second position sensor 12D. The position of the shutter plate 12B in FIG. 2 may be corresponding to the close time point T_{C,1} of the shutter action timing diagram ST. The controller 120 may control the shutter plate 12B rotates to a position as illustrated in FIG. 2 which is corresponding to the close time point T_{C,1} of the shutter action timing diagram ST in FIG. 5 so that the close position of the shutter plate 12B (as illustrated in FIG. 2) is consistent with the close time point T_{C,1} of the shutter action timing diagram ST. The processes in FIG. 11 may be called “position calibration of the shutter plate”.

The above description of illustrated implementations of the disclosure, including what is described in the Abstract, is not intended to be exhaustive or to limit the disclosure to the precise forms disclosed. While specific implementations of, and examples for, the disclosure are described herein for illustrative purposes, various equivalent modifications are possible within the scope of the disclosure, as those skilled in the relevant art will recognize.

These modifications may be made to the disclosure in light of the above detailed description. The terms used in the following claims should not be construed to limit the disclosure to the specific implementations disclosed in the specification and the claims. Rather, the scope of the disclosure is to be determined entirely by the following claims, which are to be construed in accordance with established doctrines of claim interpretation.

According to the present disclosure, an exposure apparatus includes a light detecting device for detecting a light leakage leaking from the shutter module and accordingly outputting an alarm signal immediately. In another embodiment, in response to the alarm signal, the light detecting device may calibrate the position of the shutter plate. In another embodiment, in response to the alarm signal, the light detecting device may adjust the luminous intensity of the illumination light emitted by the light source according to the illumination ratio (IL ratio).

Example embodiment 1: a light detecting device includes a light sensor and a controller. The light sensor is configured to generate a first detection value by detecting a region in an optical path of the illumination light at a first time point during a close period of a shutter action timing diagram. The controller is electrically connected with the light sensor and configured to obtain the first detection value; determine whether the first detection value is less than a first preset value; and if the first detection value is less than the first preset value, output an alarm signal.

Example embodiment 2 based on Example embodiment 1: the light sensor is further configured to generate a second detection value by detecting the region in the optical path of the illumination light at a second time point during the close period of the shutter action timing diagram. The controller is further configured to: obtain a second detection value by detecting the region in the optical path of the illumination light at a second time point during the close period of the shutter action timing diagram; determine whether the second detection value is less than a second preset value; and if the second detection value is less than the second preset value, output the alarm signal. The second detection value and the first detection value are different.

Example embodiment 3 based on Example embodiment 2: the second preset value is greater than the first preset value.

Example embodiment 4 based on Example embodiment 1: the light sensor is further configured to generate a third detection value by detecting the region in the optical path of the illumination light at a third time point during an open period of the shutter action timing diagram. The controller is further configured to obtain the third detection value; determine whether the third detection value is greater than a third preset value; and if the third detection value is greater than the third preset value, output the alarm signal.

Example embodiment 5 based on Example embodiment 1: the light sensor is further configured to generate a fourth detection value by detecting the region in the optical path of the illumination light at a fourth time point during a wafer transfer period of the shutter action timing diagram. The controller is further configured to obtain a fourth detection value; determine whether the fourth detection value is less than a fourth preset value; and if the fourth detection value is less than the fourth preset value, output the alarm signal.

Example embodiment 6 based on Example embodiment 1: a shutter plate is pivotally connected with a shutter carrier; the light detecting device further includes a first position sensor disposed on the shutter carrier, a second position sensor disposed on the shutter carrier, and a driving module electrically connected with the controller and mechanically connected with the shutter plate.

Example embodiment 7 based on Example embodiment 6: the controller is further configured to in response to the alarm signal, control the driving module to drive the shutter plate to rotate until the shutter plate is detected by the first position sensor and the second position sensor; and record the parameter of the driving module when the shutter plate is detected by the first position sensor and the second position sensor.

Example embodiment 8 based on Example embodiment 6: the shutter carrier has a translucent area, the shutter plate is pivotally connected with the shutter carrier at a pivot shaft, the pivot shaft, the first position sensor and the second position sensor construct three vertices of a triangular shape, and the triangular shape covers entirety of the translucent area.

Example embodiment 9 based on Example embodiment 1: the controller is further configured to obtain an illumination ratio; in response to the alarm signal, determine whether the illumination ratio fails; if the illumination ratio fails, output a luminous-intensity adjustment signal.

Example embodiment 10: a light detecting method includes the following steps: generating a first detection value by detecting a region in an optical path of the illumination light at a first time point during a close period of a shutter action timing diagram by a light sensor; obtaining the first detection value by a controller; determining whether the first detection value is less than a first preset value by the controller; and if the first detection value is less than the first preset value, outputting an alarm signal by the controller.

Example embodiment 11 based on Example embodiment 10: the light detecting method further includes: generating a second detection value by detecting the region in the optical path of the illumination light at a second time point during the close period of the shutter action timing diagram by the light sensor; obtaining a second detection value by detecting the region in the optical path of the illumination light at a second time point during the close period of the shutter action timing diagram by the controller; determining whether the second detection value is less than a second preset value by the controller; and if the second detection value is less than the second preset value, outputting the alarm signal by the controller. The second detection value and the first detection value are different.

Example embodiment 12 based on Example embodiment 11: the second preset value is greater than the first preset value.

Example embodiment 13 based on Example embodiment 10: light detecting method further includes: generating a third detection value by detecting the region in the optical path of the illumination light at a third time point during an open period of the shutter action timing diagram by the light sensor; obtaining the third detection value by the controller; determining whether the third detection value is greater than a third preset value by the controller; and if the third detection value is greater than the third preset value, outputting the alarm signal by the controller.

Example embodiment 14 based on Example embodiment 10: the light detecting method further includes: generating a fourth detection value by detecting the region in the optical path of the illumination light at a fourth time point during a wafer transfer period of the shutter action timing diagram by the light sensor; obtaining a fourth detection value by the controller; determining whether the fourth detection value is less than a fourth preset value by the light sensor; and if the fourth detection value is less than the fourth preset value, outputting the alarm signal by the light sensor.

Example embodiment 15 based on Example embodiment 10: a shutter plate is pivotally connected with a shutter carrier; the light detecting device further includes a first position sensor disposed on the shutter carrier, a second position sensor disposed on the shutter carrier and a driving module electrically connected with the controller and mechanically connected with the shutter plate.

Example embodiment 16 based on Example embodiment 15: the light detecting method further includes: in response to the alarm signal, control the driving module to drive the shutter plate to rotate by the controller until the shutter plate is detected by the first position sensor and the second position sensor; and record the parameter of the driving module by the controller when the shutter plate is detected by the first position sensor and the second position sensor.

Example embodiment 17 based on Example embodiment 15: the shutter carrier has a translucent area, the shutter plate is pivotally connected with the shutter carrier at a pivot shaft, the pivot shaft, the first position sensor and the second position sensor construct three vertices of a triangular shape, and the triangular shape covers entirety of the translucent area.

Example embodiment 18 based on Example embodiment 10: the light detecting method further includes: obtaining an illumination ratio by the controller; in response to the alarm signal, determining whether the illumination ratio fails by the controller; and if the illumination ratio fails, outputting a luminous-intensity adjustment signal by the controller.

Example embodiment 19: a light detecting device includes a light sensor and a controller. The light sensor is configured to generate a detection value by detecting a region in an optical path of the illumination light at a time point during an open period of a shutter action timing diagram. The controller is electrically connected with the light sensor and configured to obtain the detection value; determine whether the detection value is greater than a preset value; and if the detection value is greater than the preset value, output the alarm signal.

Example embodiment 20 based on Example embodiment 17: a shutter plate is pivotally connected with a shutter carrier. The light detecting device further includes a first position sensor disposed on the shutter carrier, a second position sensor disposed on the shutter carrier and a driving module electrically connected with the controller and mechanically connected with the shutter plate. The controller is further configured to: in response to the alarm signal, control the driving module to drive the shutter plate to rotate until the shutter plate is detected by the first position sensor and the second position sensor; and record the parameter of the driving module when the shutter plate is detected by the first position sensor and the second position sensor.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A light detecting device, comprising:
a light sensor configured to generate a first detection value by detecting a region in an optical path of the illumination light at a first time point during a close period of a shutter action timing diagram; and
a controller electrically connected with the light sensor and configured to:
obtain the first detection value;
determine whether the first detection value is less than a first preset value; and
if the first detection value is less than the first preset value, output an alarm signal.

2. The light detecting device according to claim 1, wherein the light sensor is further configured to generate a second detection value by detecting the region in the optical path of the illumination light at a second time point during the close period of the shutter action timing diagram; and the controller is further configured to:
obtain a second detection value by detecting the region in the optical path of the illumination light at a second time point during the close period of the shutter action timing diagram;
determine whether the second detection value is less than a second preset value; and
if the second detection value is less than the second preset value, output the alarm signal;
wherein the second detection value and the first detection value are different.

3. The light detecting device according to claim 2, wherein the second preset value is greater than the first preset value.

4. The light detecting device according to claim 1, wherein the light sensor is further configured to generate a third detection value by detecting the region in the optical path of the illumination light at a third time point during an open period of the shutter action timing diagram; the controller is further configured to:
obtain the third detection value;
determine whether the third detection value is greater than a third preset value; and
if the third detection value is greater than the third preset value, output the alarm signal.

5. The light detecting device according to claim 1, wherein the light sensor is further configured to generate a fourth detection value by detecting the region in the optical path of the illumination light at a fourth time point during a wafer transfer period of the shutter action timing diagram; the controller is further configured to:
obtain a fourth detection value;
determine whether the fourth detection value is less than a fourth preset value; and
if the fourth detection value is less than the fourth preset value, output the alarm signal.

6. The light detecting device according to claim 1, wherein a shutter plate is pivotally connected with a shutter carrier; the light detecting device further comprises:
a first position sensor disposed on the shutter carrier;
a second position sensor disposed on the shutter carrier; and
a driving module electrically connected with the controller and mechanically connected with the shutter plate.

7. The light detecting device according to claim 6, wherein the controller is further configured to:
in response to the alarm signal, control the driving module to drive the shutter plate to rotate until the shutter plate is detected by the first position sensor and the second position sensor; and
record the parameter of the driving module when the shutter plate is detected by the first position sensor and the second position sensor.

8. The light detecting device according to claim 6, wherein the shutter carrier has a translucent area, the shutter plate is pivotally connected with the shutter carrier at a pivot shaft, the pivot shaft, the first position sensor and the second position sensor construct three vertices of a triangular shape, and the triangular shape covers entirety of the translucent area.

9. The light detecting device according to claim 1, wherein the controller is further configured to:
obtain an illumination ratio;
in response to the alarm signal, determine whether the illumination ratio fails; and
if the illumination ratio fails, output a luminous-intensity adjustment signal.

10. A light detecting method, comprising:
generate a first detection value by detecting a region in an optical path of the illumination light at a first time point during a close period of a shutter action timing diagram by a light sensor;
obtain the first detection value by a controller;
determine whether the first detection value is less than a first preset value by the controller; and
if the first detection value is less than the first preset value, output an alarm signal by the controller.

11. The light detecting method according to claim 10, further comprising:
generating a second detection value by detecting the region in the optical path of the illumination light at a second time point during the close period of the shutter action timing diagram by the light sensor;
obtaining a second detection value by detecting the region in the optical path of the illumination light at a second time point during the close period of the shutter action timing diagram by the controller;
determining whether the second detection value is less than a second preset value by the controller; and
if the second detection value is less than the second preset value, outputting the alarm signal by the controller;
wherein the second detection value and the first detection value are different.

12. The light detecting method according to claim 11, wherein the second preset value is greater than the first preset value.

13. The light detecting method according to claim 10, further comprising:
generating a third detection value by detecting the region in the optical path of the illumination light at a third time point during an open period of the shutter action timing diagram by the light sensor;
obtaining the third detection value by the controller;
determining whether the third detection value is greater than a third preset value by the controller; and
if the third detection value is greater than the third preset value, outputting the alarm signal by the controller.

14. The light detecting method according to claim 10, further comprising:
generating a fourth detection value by detecting the region in the optical path of the illumination light at a fourth time point during a wafer transfer period of the shutter action timing diagram by the light sensor;
obtaining a fourth detection value by the controller;
determining whether the fourth detection value is less than a fourth preset value by the light sensor; and
if the fourth detection value is less than the fourth preset value, outputting the alarm signal by the light sensor.

15. The light detecting method according to claim 10, wherein a shutter plate is pivotally connected with a shutter carrier; the light detecting device further comprises a first position sensor disposed on the shutter carrier, a second position sensor disposed on the shutter carrier and a driving module electrically connected with the controller and mechanically connected with the shutter plate.

16. The light detecting method according to claim 15, wherein the light detecting method further comprises:
in response to the alarm signal, controlling the driving module to drive the shutter plate to rotate by the controller until the shutter plate is detected by the first position sensor and the second position sensor; and
recording the parameter of the driving module by the controller when the shutter plate is detected by the first position sensor and the second position sensor.

17. The light detecting method according to claim 15, wherein the shutter carrier has a translucent area, the shutter plate is pivotally connected with the shutter carrier at a pivot shaft, the pivot shaft, the first position sensor and the second position sensor construct three vertices of a triangular shape, and the triangular shape covers entirety of the translucent area.

18. The light detecting method according to claim 10, further comprising:
obtaining an illumination ratio by the controller;
in response to the alarm signal, determining whether the illumination ratio fails by the controller; and
if the illumination ratio fails, outputting a luminous-intensity adjustment signal by the controller.

19. A light detecting device, comprising:
a light sensor configured to generate a detection value by detecting a region in an optical path of the illumination light at a time point during an open period of a shutter action timing diagram; and
a controller electrically connected with the light sensor and configured to:
obtain the detection value;
determine whether the detection value is greater than a preset value; and
if the detection value is greater than the preset value, output the alarm signal.

20. The light detecting device according to claim 19, wherein a shutter plate is pivotally connected with a shutter carrier; the light detecting device further comprises a first position sensor disposed on the shutter carrier, a second position sensor disposed on the shutter carrier and a driving module electrically connected with the controller and mechanically connected with the shutter plate; the controller is further configured to:
in response to the alarm signal, control the driving module to drive the shutter plate to rotate until the shutter plate is detected by the first position sensor and the second position sensor; and
record the parameter of the driving module when the shutter plate is detected by the first position sensor and the second position sensor.
